(19) United States
(12) Patent Application Publication
(10) Pub. No.: US 2018/0032142 A1
(43) Pub. Date: Feb. 1, 2018

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: Soshi Oshima, Toride-shi (JP)

(21) Appl. No.: 15/658,114

(22) Filed: Jul. 24, 2017

(30) Foreign Application Priority Data
Jul. 28, 2016 (JP) 2016-148209

(51) Int. Cl. G06F 3/01; G06F 3/0354; G06F 3/0482

(52) U.S. Cl. CPC G06F 3/017; G06F 3/0482; G06F 3/03545

(57) ABSTRACT

At least one embodiment of an information processing apparatus according to the present invention provided herein includes a display unit that displays an image including an item on a plane, an imaging unit that captures the image including the item on the plane from above the plane; an identification unit that identifies a position of a pointer from the image captured by the imaging unit, an acquisition unit that acquires a distance between the plane and the pointer, a selection unit that, when the position of the pointer identified by the identification unit in the image captured by the imaging unit falls within a predetermined area including at least part of the item, selects the item, and a control unit that changes a size of the predetermined area based on the distance acquired by the acquisition unit.

### BACKGROUND OF THE INVENTION

### Field of the Invention

The present disclosure relates to one or more embodiments of an information processing apparatus, a control method thereof, and a storage medium.

### Description of the Related Art

There have been proposed some information processing apparatuses that capture an image of an operation plane on a desk or a platen glass by a visible-light camera or an infrared camera and detect from the captured image the position of an object within an imaging area or a gesture made by a user's hand.

In the information processing apparatuses as described above, the user performs gesture operations such as a touch operation of touching the operation plane by a finger or a touch pen and a hover operation by holding a finger or a touch pen over the operation plane. When detecting the hover operation, the information processing apparatus may illuminate an item such as an object directly ahead of the fingertip or the touch pen.

Japanese Patent Laid-Open No. 2015-215840 describes an information processing apparatus that sets an area in which an object is displayed as an area reactive to a touch operation and sets an area larger at a predetermined degree than the area reactive to a touch operation as an area reactive to a hover operation.

In the information processing apparatus as described above, there exists an area in which a hover operation over the object is accepted but no touch operation on the object is accepted. Accordingly, after a hover operation over the object is detected, when the user moves the fingertip to perform a touch operation on the object, the user may end up performing a touch operation in the area where no touch operation on the object is accepted.

For example, as illustrated in FIG. 10E, the user holds a fingertip over the operation plane to perform a hover operation over an object 1022. This operation is determined as a hover operation over the object 1022. The information processing apparatus changes the color of the object 1022 or the like to notify the user that the object 1022 is selected by the hover operation. At that time, the user moves the fingertip along a direction 1020 vertical to the operation plane to perform a touch operation on the object 1022 selected by the hover operation. Accordingly, the user ends up performing a touch operation in the area without the object 1022, and no touch operation on the object 1022 is accepted.

### SUMMARY OF THE INVENTION

At least one embodiment of an information processing apparatus described herein is an information processing apparatus that detects an operation over the operation plane, and at least one object of the information processing apparatus is to change the area reactive to a hover operation depending on the distance between the user's fingertip and the operation plane to guide the fingertip of the user to the display area of the object.

At least one embodiment of an information processing apparatus described herein includes: a processor; and a memory storing instructions, when executed by the processor, causing the information processing apparatus to function as: a display unit that displays an image including an item on a plane; an imaging unit that captures the image including the item on the plane from above the plane; an identification unit that identifies a position of a pointer from the image captured by the imaging unit; an acquisition unit that acquires a distance between the plane and the pointer; a selection unit that, when the position of the pointer identified by the identification unit in the image captured by the imaging unit falls within a predetermined area including at least part of the item, selects the item; and a control unit that changes a size of the predetermined area based on the distance acquired by the acquisition unit.

According to other aspects of the present disclosure, one or more additional information processing apparatuses, one or more methods for controlling same, and one or more storage mediums for use therewith are discussed herein. Further features of the present disclosure will become apparent from the following description of exemplary embodiments (with reference to the attached drawings).

### BRIEF DESCRIPTION OF THE DRAWINGS

FIG. 1 is a diagram illustrating an example of a network configuration of a camera scanner 101.

FIGS. 2A to 2C are diagrams illustrating examples of outer appearance of the camera scanner 101.

FIG. 3 is a diagram illustrating an example of a hardware configuration of a controller unit 201.

FIG. 4 is a diagram illustrating an example of a functional configuration of a control program for the camera scanner 101.

FIGS. 5A to 5D are a flowchart and illustrative diagrams, respectively, of at least one embodiment of a process executed by a distance image acquisition unit 408.

FIGS. 6A to 6D are a flowchart and illustrative diagrams, respectively, of at least one embodiment of a process executed by a CPU 302.

FIG. 7 is a flowchart of a process executed by the CPU 302 according to at least a first embodiment.

FIGS. 8A to 8G are schematic diagrams of an operation plane 204 and an object management table, respectively, according to at least the first embodiment.

FIG. 9 is a flowchart of a process executed by a CPU 302 according to at least a second embodiment.

FIGS. 10A to 10F are schematic diagrams of an operation plane 204 and an object management table, respectively, according to at least the second embodiment.

FIG. 11 is a flowchart of a process executed by a CPU 302 according to at least a third embodiment.

FIG. 12 is a diagram illustrating the relationship between an operation plane 204 and a user according to at least the third embodiment.

FIG. 13 is a flowchart of a process executed by a CPU 302 according to at least a fourth embodiment.

FIG. 14 is a diagram illustrating the relationship between an operation plane 204 and a user according to at least the fourth embodiment.

### DESCRIPTION OF THE EMBODIMENTS

### First Embodiment

Best mode for carrying out an embodiment described herein will be described below with reference to the drawings.

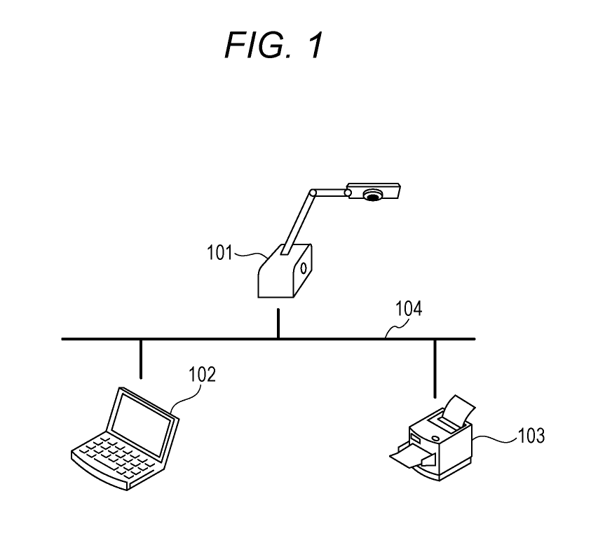

FIG. 1 is a diagram illustrating a network configuration including a camera scanner 101 according to the embodiment.

As illustrated in FIG. 1, the camera scanner 101 is connected to a host computer 102 and a printer 103 via a network 104 such as Ethernet (registered trademark). In the network configuration of FIG. 1, under instructions from the host computer 102, the camera scanner 101 can perform a scanning function to read an image and the printer 103 can perform a printing function to output scanned data. In addition, the user can perform the scanning function and the printing function by operating the camera scanner 101 without using the host computer 102.

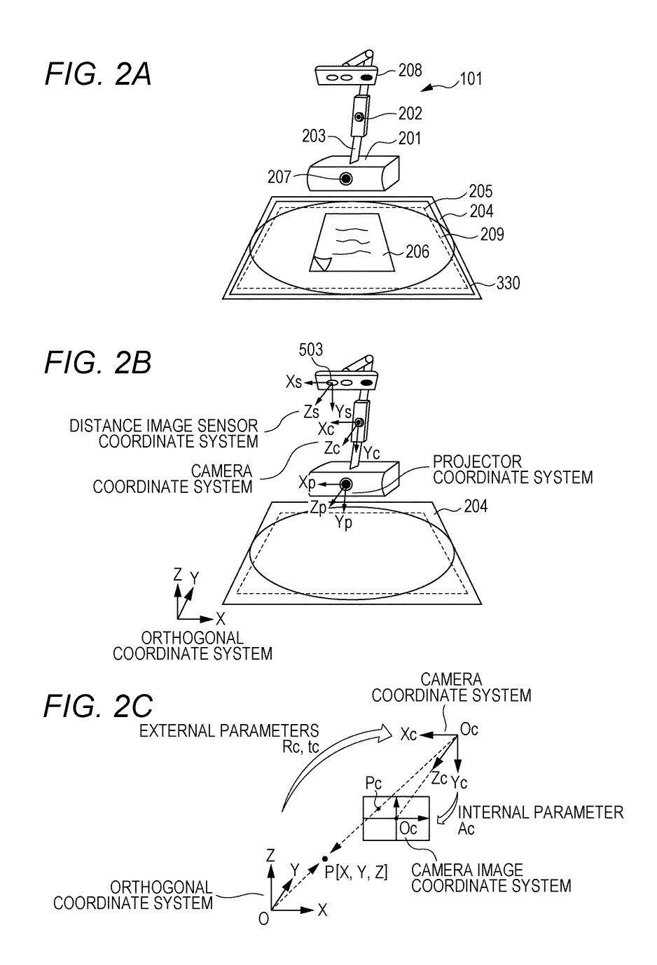

FIG. 2A is a diagram illustrating a configuration example of the camera scanner 101 according to the embodiment.

As illustrated in FIG. 2A, the camera scanner 101 includes a controller unit 201, a camera unit 202, an arm unit 203, a projector 207, and a distance image sensor unit 208. The controller unit 201 as a main body of the camera scanner and the camera unit 202, the projector 207, and the distance image sensor unit 208 for capturing images are coupled together by the arm unit 203. The arm unit 203 is bendable and expandable using joints.

The operation plane 204 is an operation plane 204 with the camera scanner 101. The lenses of the camera unit 202 and the distance image sensor unit 208 are oriented toward the operation plane 204. Referring to FIG. 2A, the camera scanner 101 reads a document 206 placed in a reading area 205 surrounded by a dashed line.

The camera unit 202 may be configured to capture images by a single-resolution camera or may be capable of high-resolution imaging and low-resolution imaging. In the latter case, two different cameras may capture high-resolution images and low-resolution images or one camera may capture high-resolution images and low-resolution images. The use of the high-resolution camera makes it possible to read accurately text and graphics from the document placed in the reading area 205. The use of a low-resolution camera makes it possible to analyze the movement of an object and the motion of the user's hand within the operation plane 204 at real time.

A touch panel may be provided in the operation plane 204. When being touched by the user's hand or a touch pen, the touch panel detects information at the position of the touch by the hand or the touch pen, and outputs the same as an information signal. The camera scanner 101 may include a speaker not illustrated. Further, the camera scanner 101 may include various sensor devices such as a human presence sensor, an illuminance sensor, and an acceleration sensor for collecting surrounding environment information.

FIG. 2B illustrates coordinate systems in the camera scanner 101. In the camera scanner 101, a camera coordinate system [Xc, Yc, Zc], a distance image coordinate system [Xs, Ys, Zs], and a projector coordinate system [Xp, Yp, Zp] are respectively defined for the camera unit 202, the projector 207, and the distance image sensor unit 208. These coordinate systems are obtained by defining the planes of images captured by the camera unit 202 and the distance image sensor unit 208 or the plane of an image projected by the projector 207 as XY planes, and defining the direction orthogonal to the image planes as Z direction. Further, in order to treat three-dimensional data in the independent coordinate systems in a unified form, an orthogonal coordinate system is defined with the plane including the operation plane 204 as XY plane and the orientation upwardly vertical to the XY plane as Z axis.

As an example of coordinate system conversion, FIG. 2C illustrates the relationship among the orthogonal coordinate system, the space expressed by the camera coordinate system centered on the camera unit 202, and the plane of the image captured by the camera unit 202. Point P[X, Y, Z] in the orthogonal coordinate system can be converted into a point Pc[Xc, Yc, Zc] in the camera coordinate system by Equation (1) as follows:

[Xc, Yc, Zc]^{T}=[Rc|tc][X, Y, Z, 1]^{T} (1)

In the foregoing equation, Rc and tc represent external parameters determined by the orientation (rotation) and position (transition) of the camera with respect to the orthogonal coordinate system. Rc will be called 3×3 rotation matrix and tc transitional vector. The matrixes Rc and tc are set at the time of factory shipment and are to be changed at the time of maintenance by service engineers or the like after the factory shipment.

A three-dimensional point defined in the camera coordinate system is converted into the orthogonal coordinate system by Equation (2) as follows:

[X, Y, Z]^{T}=[Rc⁻¹|−Rc⁻¹tc][Xc, Yc, Zc, 1]^{T} (2)

The plane of a two-dimensional camera image captured by the camera unit 202 is obtained by converting three-dimensional information in the three-dimensional space into two-dimensional information by the camera unit 202. A three-dimensional point Pc[Xc, Yc, Zc] in the camera coordinate system is subjected to perspective projection and converted into a two-dimensional point pc[xp, yp] on the camera image plane by Equation (3) as follows:

λ[xp, yp, 1]^{T}=A[Xc, Yc, Zc]^{T} (3)

In the foregoing equation, A is called camera internal parameter that represents a predetermined 3×3 matrix expressed by the focal distance, the image center, and the like. In addition, A is an arbitrary coefficient.

As described above, by using Equations (1) and (3), the three-dimensional point groups expressed in the orthogonal coordinate system are converted into the three-dimensional point group coordinate in the camera coordinate system and the camera image plane. The internal parameters of the hardware devices, and the positions and orientations (external parameters) of the hardware devices with respect to the orthogonal coordinate system are calibrated in advance by a publicly known calibration method. In the following description, unless otherwise specified, the three-dimensional point group will refer to three-dimensional data in the orthogonal coordinate system.

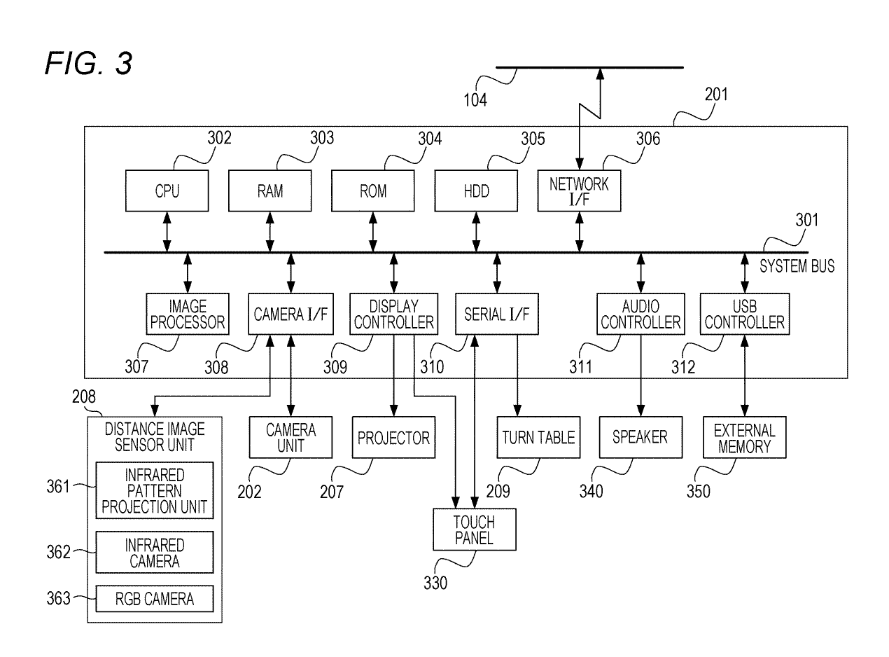

FIG. 3 is a diagram illustrating a hardware configuration example of the controller unit 201 as the main unit of the camera scanner 101.

As illustrated in FIG. 3, the controller unit 201 includes a CPU 302, a RAM 303, a ROM 304, an HDD 305, a network I/F 306, and an image processing processor 307, all of which are connected to a system bus 301. In addition, the controller unit 201 also includes a camera I/F 308, a display controller 309, a serial I/F 310, an audio controller 311, and a USB controller 312 connected to the system bus 301.

The CPU 302 is a central computing device that controls the overall operations of the controller unit 201. The RAM 303 is a volatile memory. The ROM 304 is a non-volatile memory that stores a boot program for the CPU 302. The HDD 305 is a hard disk drive (HDD) larger in capacity than the RAM 303. The HDD 305 stores a control program for the camera scanner 101 to be executed by the controller unit 201.

At the time of startup such as power-on, the CPU 302 executes the boot program stored in the ROM 304. The boot program is designed to read the control program from the HDD 305 and develop the same in the RAM 303. After the execution of the boot program, the CPU 302 then executes the control program developed in the RAM 303 to control the camera scanner 101. The CPU 302 also stores data for use in the operation in the control program in the RAM 303 for reading and writing. Further, various settings necessary for operation in the control program and image data generated by camera input can be stored in the HDD 305 so that the CPU 302 can read and write the same. The CPU 302 communicates with other devices on the network 104 via the network I/F 306.

The image processing processor 307 reads and processes the image data from the RAM 303, and then writes the processed image data back into the RAM 303. The image processing executed by the image processing processor 307 includes rotation, scaling, color conversion, and the like.

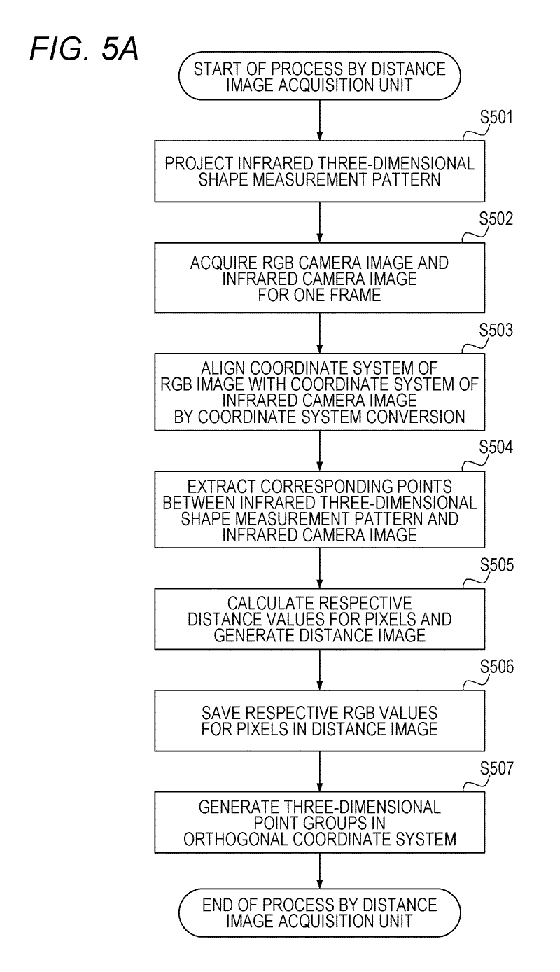

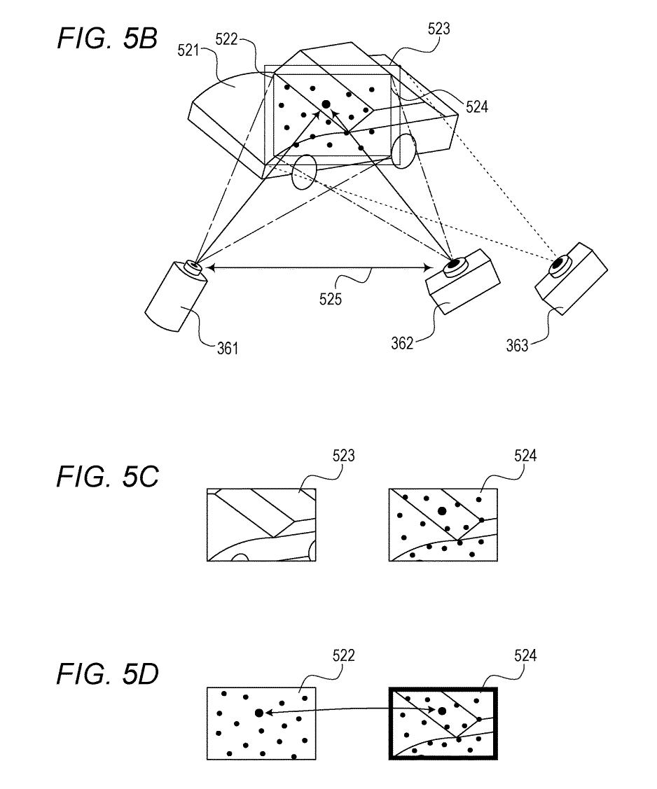

The camera I/F 308 connects to the camera unit 202 and the distance image sensor unit 208. The camera I/F 308 writes the image data acquired from the camera unit 202 and the distance image data acquired from the distance image sensor unit 208 into the RAM 303 under instructions from the CPU 302. The camera I/F 308 also transmits a control command from the CPU 302 to the camera unit 202 and the distance image sensor unit 208 to set the camera unit 202 and the distance image sensor unit 208. To generate the distance image, the distance image sensor unit 208 includes an infrared pattern projection unit 361, an infrared camera 362, and an RGB camera 363. The process for acquiring the distance image by the distance image sensor unit 208 will be described later with reference to FIG. 5.

The display controller 309 controls display of image data on the display under instructions from the CPU 302. In this example, the display controller 309 is connected to the projector 207 and a touch panel 330.

The serial I/F 310 inputs and outputs serial signals. The serial I/F 310 connects to a turn table 209, for example, to transmit instructions for starting and ending the rotation of the CPU 302 and setting the rotation angle to the turn table 209. The serial I/F 310 also connects to the touch panel 330 so that, when the touch panel is pressed, the CPU 302 acquires coordinates at the pressed position via the serial I/F 310. The CPU 302 also determines whether the touch panel 330 is connected via the serial I/F 310.

The audio controller 311 is connected to a speaker 340 to convert audio data into an analog voice signal and output the audio through the speaker 340 under instructions from the CPU 302.

The USB controller 312 controls an external USB device under instructions from the CPU 302. In this example, the USB controller 312 is connected to an external memory 350 such as a USB memory or an SD card to read and write data from and into the external memory 350.

In the embodiment, the controller unit 201 includes all the display controller 309, the serial I/F 310, the audio controller 311, and the USB controller 312. However, the controller unit 201 may include at least one of the foregoing components.

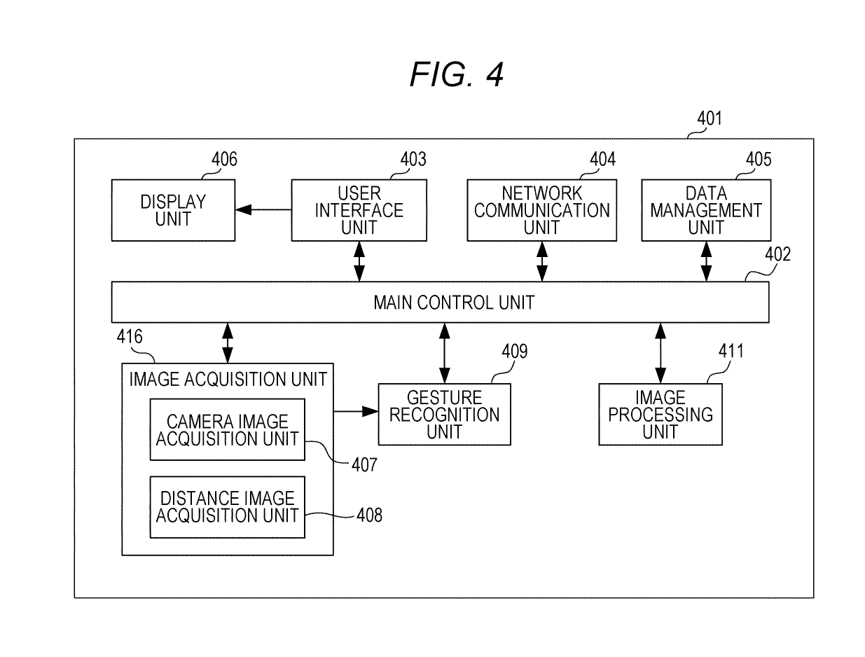

FIG. 4 is a diagram illustrating an example of a functional configuration 401 of the control program for the camera scanner 101 to be executed by the CPU 302.

The control program for the camera scanner 101 is stored in the HDD 305 as described above. At the time of startup, the CPU 302 develops and executes the control program in the RAM 303.

A main control unit 402 serves as the center of the control to control the other modules in the functional configuration 401.

An image acquisition unit 416 is a module that performs image input processing and includes a camera image acquisition unit 407 and a distance image acquisition unit 408. The camera image acquisition unit 407 acquires the image data output from the camera unit 202 via the camera I/F 308 and stores the same in the RAM 303. The distance image acquisition unit 408 acquires the distance image data output from the distance image sensor unit 208 via the camera I/F 308 and stores the same in the RAM 303. The process performed by the distance image acquisition unit 408 will be described later in detail with reference to FIG. 5.

An image processing unit 411 is used to analyze the images acquired from the camera unit 202 and the distance image sensor unit 208 by the image processing processor 307 and includes various image processing modules.

A user interface unit 403 generates GUI parts such as messages and buttons in response to a request from the main control unit 402. Then, the user interface unit 403 requests a display unit 406 to display the generated GUI parts. The display unit 406 displays the requested GUI parts on the projector 207 via the display controller 309. The projector 207 is oriented toward the operation plane 204 and projects the GUI parts onto the operation plane 204. The user interface unit 403 also receives a gesture operation such as a touch recognized by a gesture recognition unit 409 and its coordinates through the main control unit 402. Then, the user interface unit 403 determines the operation content from the correspondence between the operation screen under rendering and the operation coordinates. The operation content indicates which button on the touch panel 330 has been touched by the user, for example. The user interface unit 403 notifies the operation content to the main control unit 402 to accept the operator's operation.

A network communication unit 404 communicates with the other devices on the network 104 via the network I/F 306 under Transmission Control Protocol (TCP)/IP.

A data management unit 405 saves and manages various data such as work data generated at execution of the control program 401 in a predetermined area of the HDD 305.

FIGS. 5A to 5D are diagrams describing a process for determining the distance image and the three-dimensional point groups in the orthogonal coordinate system from the imaging data captured by the distance image sensor unit 208. The distance image sensor unit 208 is a distance image sensor using infrared pattern projection. The infrared pattern projection unit 361 projects a three-dimensional shape measurement pattern by infrared rays invisible to the human eye onto a subject. The infrared camera 362 is a camera that reads the three-dimensional shape measurement pattern projected onto the subject. The RGB camera 363 is a camera that captures an image of light visible to the human eye.

A process for generating the distance image by the distance image sensor unit 208 will be described with reference to the flowchart in FIG. 5A. FIGS. 5B to 5D are diagrams for describing the principles for measuring the distance image by the pattern projection method.

The infrared pattern projection unit 361, the infrared camera 362, and the RGB camera 363 illustrated in FIG. 5B are included in the distance image sensor unit 208.

In the embodiment, the infrared pattern projection unit 361 is used to project a three-dimensional shape measurement pattern 522 onto the operation plane, and the operation plane after the projection is imaged by the infrared camera 362. The three-dimensional shape measurement pattern 522 and the image captured by the infrared camera 362 are compared to each other to generate three-dimensional point groups indicating the position and size of the object on the operation plane, thereby generating the distance image.

The HDD 305 stores a program for executing the process described in FIG. 5A. The CPU 302 executes the program stored in the HDD 305 to perform the process as described below.

The process described in FIG. 5A is started when the camera scanner 101 is powered on.

The distance image acquisition unit 408 projects the three-dimensional shape measurement pattern 522 by infrared rays from the infrared pattern projection unit 361 onto a subject 521 as illustrated in FIG. 5B (S501). The three-dimensional shape measurement pattern 522 is a predetermined pattern image that is stored in the HDD 305.

The distance image acquisition unit 408 acquires an RGB camera image 523 by imaging the subject by a RGB camera 363 and an infrared camera image 524 by imaging the three-dimensional shape measurement pattern 522 projected at step S501 by the infrared camera 362 (S502).

The infrared camera 362 and the RGB camera 363 are different in installation location. Therefore, the RGB camera image 523 and the infrared camera image 524 captured respectively by the infrared camera 362 and the RGB camera 363 are different in imaging area as illustrated in FIG. 5C. Accordingly, the distance image acquisition unit 408 performs coordinate system conversion to convert the infrared camera image 524 into the coordinate system of the RGB camera image 523 (S503). The relative positions of the infrared camera 362 and the RGB camera 363 and their respective internal parameters are known in advance by a calibration process. The distance image acquisition unit 408 performs the coordinate conversion using these values.

The distance image acquisition unit 408 extracts corresponding points between the three-dimensional shape measurement pattern 522 and the infrared camera image 524 subjected to the coordinate conversion at S503 (S504). For example, as illustrated in FIG. 5D, the distance image acquisition unit 408 searches the three-dimensional shape measurement pattern 522 for one point in the infrared camera image 524. When detecting the identical point, the distance image acquisition unit 408 establishes the correspondence between the points. Alternatively, the distance image acquisition unit 408 may search the three-dimensional shape measurement pattern 522 for a peripheral pixel pattern in the infrared camera image 524 and establishes the correspondence between the portions highest in similarity.

The distance image acquisition unit 408 performs a calculation, based on the principles of triangulation, with a straight line linking the infrared pattern projection unit 361 and the infrared camera 362 as a base line 525, thereby to determine the distance from the infrared camera 362 to the subject (S505). For the pixel of which the correspondence was established at S504, the distance from the infrared camera 362 is calculated and saved as a pixel value. For the pixel of which no correspondence was established, an invalid value is saved as a portion where distance measurement is disabled. The distance image acquisition unit 408 performs the foregoing operation on all the pixels in the infrared camera image 524 subjected to the coordinate conversion at S503, thereby to generate the distance image in which the distance values are set in the pixels.

The distance image acquisition unit 408 saves the RGB values in the RGB camera image 523 for the pixels in the distance image to generate the distance image in which one each pixel has four values of R, G, B, and distance (S506). The acquired distance image is formed with reference to the distance image sensor coordinate system defined by the RGB camera 363 of the distance image sensor unit 208.

The distance image acquisition unit 408 converts the distance data obtained as the distance image sensor coordinate system into three-dimensional point groups in the orthogonal coordinate system as described above with reference to FIG. 2B (S507).

In this example, the distance image sensor unit 208 in the infrared pattern projection mode is employed as described above. However, any other distance image sensor can be used. For example, any other measurement unit may be used such as a stereo-mode sensor in which stereoscopic vision is implemented by two RGB cameras or a time-of-flight (TOF)-mode sensor that measures the distance by detecting the flying time of laser light.

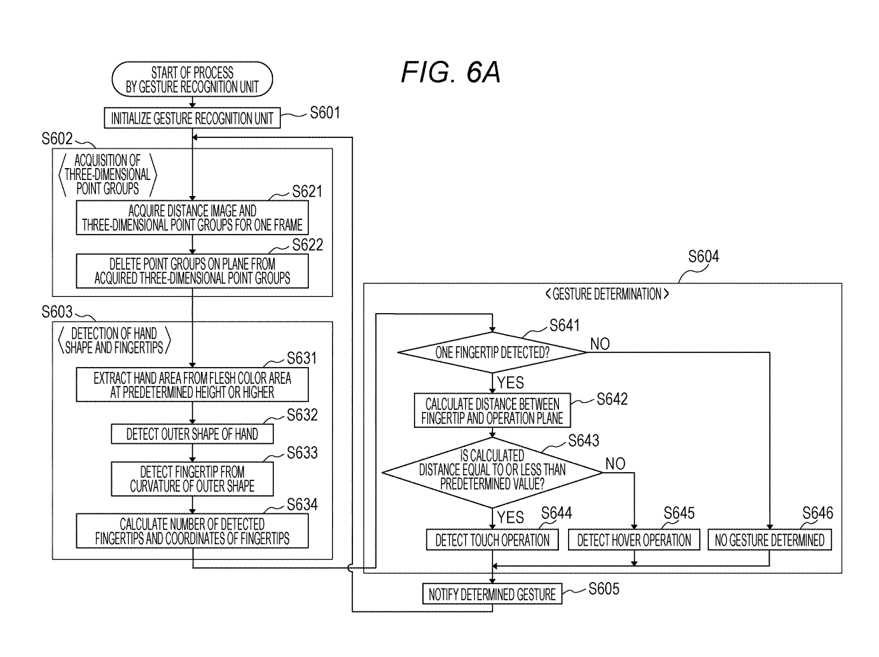

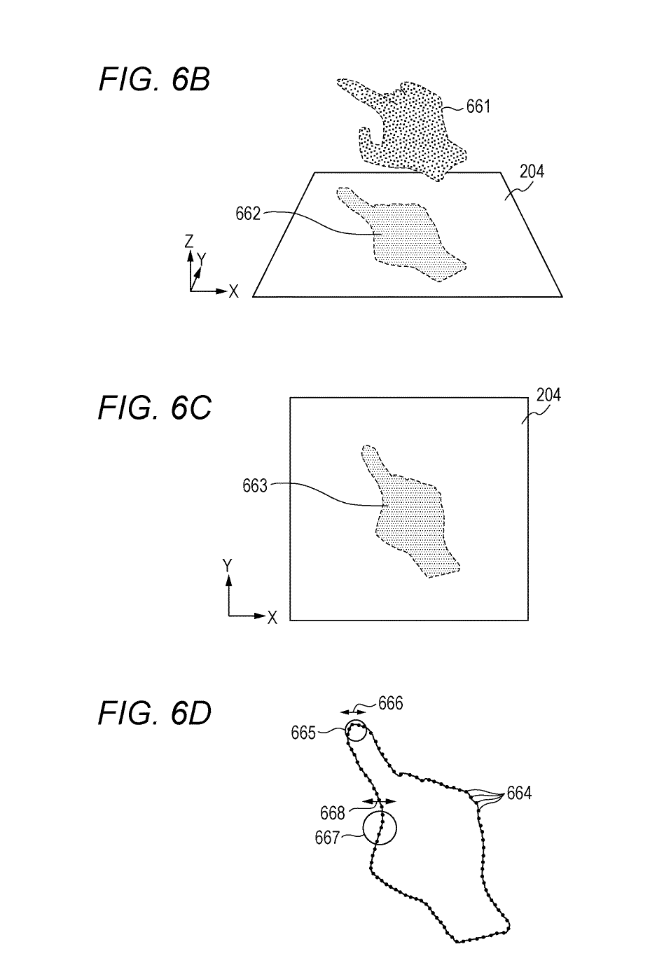

The process by the gesture recognition unit 409 will be described in detail with reference to the flowchart in FIG. 6A. The flowchart in FIG. 6A is under the assumption that the user tries to operate the operation plane 204 by a finger as an example.

Referring to FIG. 6A, the gesture recognition unit 409 extracts a human hand from the image captured by the distance image sensor unit 208, and generates a two-dimensional image by projecting the extracted image of the hand onto the operation plane 204. The gesture recognition unit 409 detects the outer shape of the human hand from the generated two-dimensional image, and detects the motion and operation of the fingertips. In the embodiment, when detecting one fingertip in the image generated by the distance image sensor unit 208, the gesture recognition unit 409 determines that a gesture operation is performed, and then identifies the kind of the gesture operation.

In the embodiment, the user moves their fingertip to operate the camera scanner 101. Instead of the user's fingertip, an object of a predetermined shape such as a tip of a stylus pen or a pointing bar may be used to operate the camera scanner 101. The foregoing objects used for operating the camera scanner 101 will be hereinafter collectively called pointer.

The HDD 305 of the camera scanner 101 stores a program for executing the flowchart described in FIG. 6A. The CPU 302 executes the program to perform the process described in the flowchart.

When the camera scanner 101 is powered on and the gesture recognition unit 409 starts operation, the gesture recognition unit 409 performs initialization (S601). In the initialization process, the gesture recognition unit 409 acquires one frame of distance image from the distance image acquisition unit 408. No object is placed on the operation plane 204 at power-on of the camera scanner 101. The gesture recognition unit 409 recognizes the operation plane 204 based on the acquired distance image. The gesture recognition unit 409 recognizes the plane by extracting the widest plane from the acquired distance image, calculating its position and normal vector (hereinafter called plane parameters of the operation plane 204), and storing the same in the RAM 303.

Subsequently, the gesture recognition unit 409 executes the three-dimensional point group acquisition process in accordance with the detection of an object or the user's hand within the operation plane 204 (S602). The three-dimensional point group acquisition process executed by the gesture recognition unit 409 is described in detail at S621 and S622. The gesture recognition unit 409 acquires one frame of three-dimensional point groups from the image acquired by the distance image acquisition unit 408 (S621). The gesture recognition unit 409 uses the plane parameters of the operation plane 204 to delete point groups in the plane including the operation plane 204 from the acquired three-dimensional point groups (S622).

The gesture recognition unit 409 detects the shape of the operator's hand and fingertips from the acquired three-dimensional point groups (S603). The process at S603 will be described in detail with reference to S631 to S634, and a method of fingertip detection will be described with reference to the schematic drawings in FIGS. 6B to 6D.

The gesture recognition unit 409 extracts from the three-dimensional point groups acquired at S602, a flesh color three-dimensional point group at a predetermined height or higher from the plane including the operation plane 204 (S631). By executing the process at S631, the gesture recognition unit 409 extracts only the operator's hand from the image acquired by the distance image acquisition unit 408. FIG. 6B illustrates the three-dimensional point group 661 of the hand extracted by the gesture recognition unit 409.

The gesture recognition unit 409 projects the extracted three-dimensional point group of the hand onto the plane including the operation plane 204 to generate a two-dimensional image and detect the outer shape of the hand (S632). FIG. 6B illustrates the three-dimensional point group 662 obtained by projecting the three-dimensional point group 661 onto the plane including the operation plane 204. In addition, as illustrated in FIG. 6C, only the values of the XY coordinates are retrieved from the projected three-dimensional point group and treated as a two-dimensional image 663 seen from the Z axis direction. At that time, the gesture recognition unit 409 memorizes the correspondences between the respective points in the three-dimensional point group of the hand and the respective coordinates of the two-dimensional image projected onto the plane including the operation plane 204.

The gesture recognition unit 409 calculates the curvatures of the respective points in the outer shape of the detected hand, and detects the points with the calculated curvatures smaller than a predetermined value as the points of a fingertip (S633). FIG. 6D illustrates schematically a method for detecting the fingertip from the curvatures in the outer shape. Reference number 664 represents some of the points representing the outer shape of the two-dimensional image 663 projected onto the plane including the operation plane 204. In this example, the gesture recognition unit 409 draws circles including five adjacent ones of the points 664 representing the outer shape. The circles 665 and 667 are examples of circles drawn to contain five adjacent points. The gesture recognition unit 409 draws circles in sequence for all the points in the outer shape, and determines that the five points in the circle constitute a fingertip when the diameter (for example, 666 or 668) of the circle is smaller than a predetermined value. For example, referring to FIG. 6D, the diameter 666 of the circle 665 is smaller than a predetermined value, and the gesture recognition unit 409 determines that the five points in the circle 665 constitute a fingertip. In contrast to this, the diameter 668 of the circle 667 is larger than a predetermined value, and the gesture recognition unit 409 determines that the five points in the circle 667 constitute no fingertip. In the process described in FIGS. 6A to 6D, circles including five adjacent points are drawn. However, the number of points in a circle is not limited. In addition, the curvatures of the drawn circles are used here, but oval fitting may be used instead of circle fitting to detect a fingertip.

The gesture recognition unit 409 calculates the number of the detected fingertips and the respective coordinates of the fingertips (S634). The gesture recognition unit 409 obtains respective three-dimensional coordinates of the fingertips based on the correspondences between the pre-stored points in the two-dimensional image projected onto the operation plane 204 and the points in the three-dimensional point group of the hand. The coordinates of the fingertips are three-dimensional coordinates of any one of the points in the circles drawn at S632. In the embodiment, the coordinates of the fingertips are determined as described above. Alternatively, the coordinates of the centers of the circles drawn at S632 may be set the coordinates of the fingertips.

In the embodiment, the fingertips are detected from the two-dimensional image obtained by projecting the three-dimensional point group. However, the image for detection of the fingertips is not limited to this. For example, the fingertips may be detected by the same method as described above (the calculation of the curvatures in the outer shape) in the hand area extracted from a background difference in the distance image or a flesh color area in the RGB camera image. In this case, the coordinates of the detected fingertips are coordinates in the two-dimensional image such as the RGB camera image or the distance image, and thus the coordinates in the two-dimensional image needs to be converted into three-dimensional coordinates in the orthogonal coordinate system using distance information in the coordinates in the distance image.

The gesture recognition unit 409 performs a gesture determination process according to the shape of the detected hand and the fingertips (S604). The process at S604 is described as S641 to S646. In the embodiment, gesture operations include a touch operation in which the user's fingertip touches the operation surface, a hover operation in which the user performs an operation over the operation surface at a distance of a predetermined touch threshold or more from the operation surface, and others.

The gesture recognition unit 409 determines whether one fingertip was detected at S603 (S641). When determining that two or more fingertips were detected, the gesture recognition unit 409 determines that no gesture was made (S646).

When determining that one fingertip was detected at S641, the gesture recognition unit 409 calculates the distance between the detected fingertip and the plane including the operation plane 204 (S642).

The gesture recognition unit 409 determines whether the distance calculated at S642 is equal to or less than the predetermined value (touch threshold) (S643). The touch threshold is a value predetermined and stored in the HDD 305.

When the distance calculated at S642 is equal to or less than the predetermined value, the gesture recognition unit 409 detects a touch operation in which the fingertip touched the operation plane 204 (S644).

When the distance calculated at S642 is not equal to or less than the predetermined value, the gesture recognition unit 409 detects a hover operation (S645).

The gesture recognition unit 409 notifies the determined gesture to the main control unit 402, and returns to S602 to repeat the gesture recognition process (S605).

When the camera scanner 101 is powered off, the gesture recognition unit 409 terminates the process described in FIG. 6A.

In this example, the gesture made by one fingertip is recognized. However, the foregoing process is also applicable to recognition of gestures made by two or more fingers, a plurality of hands, arms, and the entire body.

In the embodiment, the process illustrated in FIG. 6A is started when the camera scanner 101 is powered on. Besides the foregoing case, the gesture recognition unit may start the process illustrated in FIG. 6A when the user selects a predetermined application for using the camera scanner 101 and the application is started.

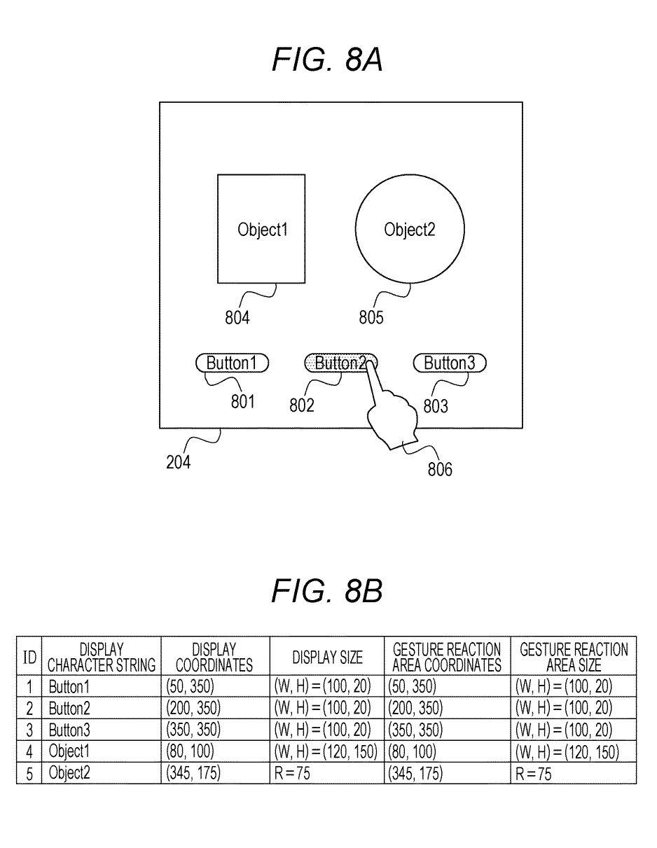

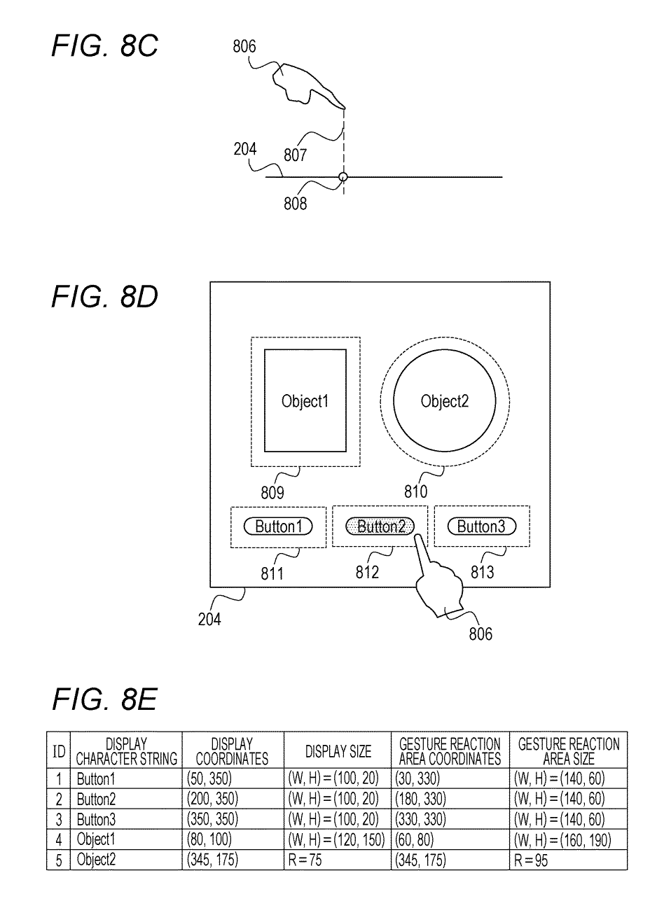

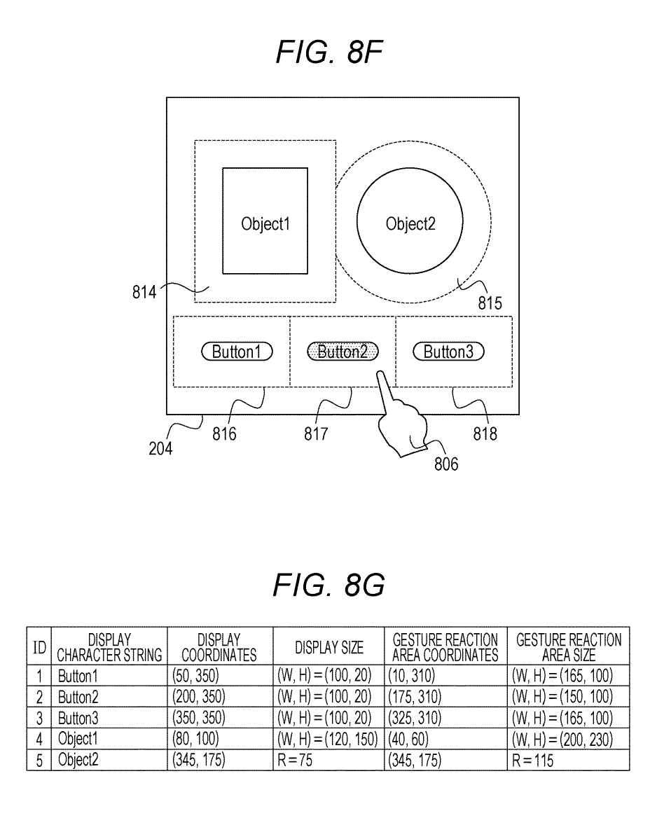

Descriptions will be given as to how a gesture reaction area for hover operation changes with changes in the distance between the operation plane 204 and the fingertip with reference to the schematic diagram of FIG. 8.

In the embodiment, the size of the gesture operation area reactive to a hover operation is changed based on the height of the fingertip detected by the gesture recognition unit 409.

The hover operation here refers to an operation performed by a fingertip on a screen projected by the projector 207 of the camera scanner 101 onto the operation plane 204 while the fingertip is hovered the touch threshold or more over the operation plane 204.

FIG. 8C is a side view of a hand 806 performing a hover operation over the operation plane 204. Reference number 807 represents a line vertical to the operation plane 204. When the distance between a point 808 and the hand 806 is equal to or more than the touch threshold, the camera scanner 101 determines that the user is performing a hover operation.

In the embodiment, when hover coordinates (X, Y, Z) of the fingertip represented in the orthogonal coordinate system are located above the gesture operation area, the display manner of the object such as the color is changed. The point 808 is a point projected onto the ZY plane where the value of the Z coordinate in the hover coordinates (X, Y, Z) is set to 0.

In the embodiment, the object projected by the projector 207 is an item such as a graphic, an image, or an icon.

FIGS. 8A and 8B illustrate a user interface projected by the projector 207 when the user performs a touch operation on the operation plane 204 and an object management table for a touch operation. When the distance between the user's fingertip and the operation plane 204 is equal to or less than a touch threshold Th, the camera scanner 101 determines that the user is performing a touch operation.

Referring to FIG. 8A, the distance between the fingertip of the user's hand 806 and the operation plane 204 is equal to or less than the touch threshold and the user's fingertip is performing a touch operation on an object 802. The camera scanner 101 accepts the touch operation performed by the user on the object 802 and changes the color of the object 802 to be different from those of the objects 801 and 803.

The objects 801 to 803 are user interface parts projected by the projector 207 onto the operation plane 204. The camera scanner 101 accepts touch operations and hover operations on the objects 801 to 803, and changes the colors of the buttons, causes screen transitions, or displays annotations about the selected objects as when physical button switches are operated.

The respective objects displayed on the screens are managed in the object management table illustrated in FIG. 8B. The types, display coordinates, and display sizes of the objects on the screens are stored in advance in the HDD 305. The CPU 302 reads information from the HDD 305 into the RAM 303 to generate the object management table.

In the embodiment, the object management table includes the items for the objects “ID,” “display character string,” “display coordinates,” “display size,” “gesture reaction area coordinates,” and “gesture reaction area size.” In the embodiment, the unit for “display size” and “gesture reaction area size” is mm in the object management table.

The “ID” of the object is a number for the object projected by the projector 207.

The item “display character string” represents a character string displayed in the object with the respective ID.

The item “display coordinates” represents where in the operation plane 204 the object with the respective ID is to be displayed. For example, the display coordinates of a rectangular object is located at an upper left point of the object, and the display coordinates of a circular object is located at the center of the circle. The display coordinates of a button object such as the objects 801 to 803 are located at the upper left of a rectangle circumscribing the object. The objects 801 to 803 are treated as rectangular objects.

The item “display size” represents the size of the object with the respective ID. For example, the display size of a rectangular object has an X-direction dimension W and a Y-direction dimension H.

The item “gesture reaction area coordinates” represents the coordinates of a reaction area where gesture operations such as a hover operation and a touch operation on the object with the respective ID are accepted. For example, for a rectangular object, a rectangular gesture reaction area is provided and its coordinates are located at an upper left point of the gesture reaction area. For a circular object, a circular gesture reaction area is provided and its coordinates are located at the center of the circle.

The item “gesture reaction area sizes” represents the size of the gesture reaction area where gesture operations such as a hover operation and a touch operation on the object with the respective ID are accepted. For example, the size of a rectangular gesture reaction area has an X-direction dimension W and a Y-direction dimension H. The size of a circular gesture reaction area has a radius R.

In the embodiment, the positions and sizes of the objects and the positions and sizes of the gesture reaction areas for the objects are managed in the object management table described above. The method for managing the objects and the object reaction areas is not limited to the foregoing one but the objects and the gesture reaction areas may be managed by any other method as far as the positions and sizes of the objects and gesture reaction areas are uniquely determined.

In the embodiment, the rectangular and circular objects are taken as examples. However, the shapes and sizes of the objects and gesture reaction areas can be arbitrarily set.

FIG. 8B illustrates the object management table for a touch operation performed by the user. The same values are described in the items “display position,” “gesture reaction area coordinates,” “display size,” and “gesture reaction area size” in the object management table. Accordingly, when the user performs a touch operation in the area where the object is displayed, the camera scanner 101 accepts the touch operation on the object.

FIGS. 8D and 8E illustrate a user interface that is projected when the user's finger is separated from the operation plane 204 by a predetermined distance equal to or more than the touch threshold Th and the user is performing a hover operation, and an object management table in this situation.

Areas 809 to 813 shown by dotted lines constitute gesture reaction areas surrounding the objects 801 to 805. The gesture operation areas shown by the dotted lines in FIG. 8D are not notified to the user. When the user's fingertip is detected within the gesture reaction area shown by the dotted line, the camera scanner 101 accepts the user's hover operation on the object.

When the user is performing a hover operation, an offset for setting the gesture reaction area size to be different from the object display size is decided depending on the distance between the fingertip and the operation plane. The offset indicates the size of the gesture reaction area relative to the object display area. FIG. 8E illustrates an object management table in the case where the amount of the offset determined from the fingertip and the operation plane 204 is 20 mm. There are differences between “display coordinates” and “gesture reaction area coordinates” and between “display size” and “gesture reaction area size.” The gesture reaction area including an offset area with 20 mm sides is provided with respect to the object display area.

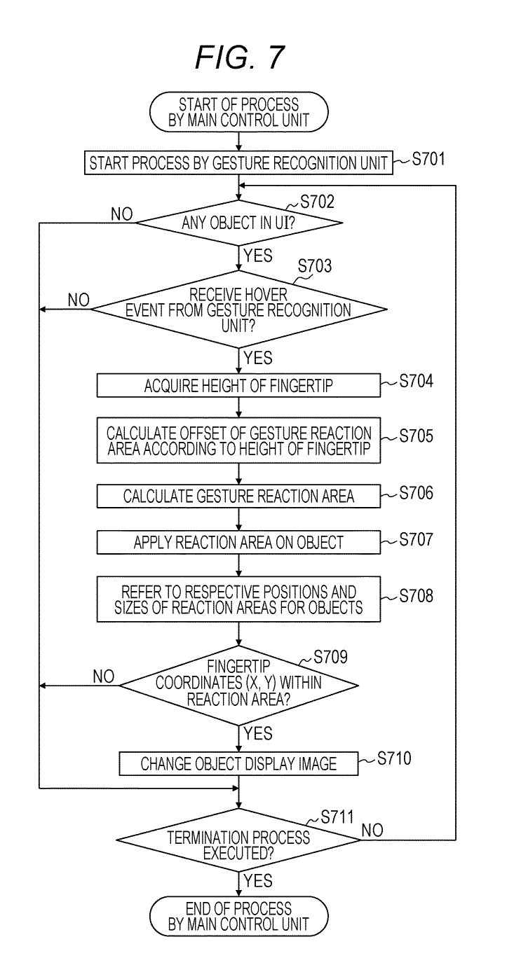

FIG. 7 is a flowchart of a process for determining the coordinates and size of the gesture reaction area in the embodiment. The HDD 305 stores a program for executing the process in the flowchart of FIG. 7 and the CPU 302 executes the program to implement the process.

The process described in FIG. 7 is started when the camera scanner 101 is powered on. In the embodiment, after the power-on, the projector 207 starts projection. The CPU 302 reads from the HDD 305 information relating to the type, display coordinates, and display size of the object to be displayed on the screen on the operation plane 204, stores the same in the RAM 303, and generates an object management table. After the camera scanner 101 is powered on, the CPU 302 reads information relating to the object to be displayed from the HDD 305 at each switching between the user interfaces displayed by the projector 207. Then, the CPU 302 stores the read information in the RAM 303 and generates an object management table.

The main control unit 402 sends a message for the start of the process to the gesture recognition unit 409 (S701). Upon receipt of the message, the gesture recognition unit 409 starts the gesture recognition process described in the flowchart of FIG. 6.

The main control unit 402 confirms whether there exists an object in the displayed user interface (S702). When no object exists, no screen is projected by the projector 207, for example. The main control unit 402 determines whether there is any object in the currently displayed screen according to the generated object management table. In the embodiment, the main control unit 402 determines at S702 whether there exists an object in the user interface. Alternatively, the main control unit 402 determines at S702 whether there is displayed any object on which the input of a gesture operation such as a touch operation or a hover operation can be accepted. The object on which the input of a gesture operation can be accepted is a button. Meanwhile, the object on which the input of a gesture operation cannot be accepted is text such as a message to the user. The HDD 305 stores in advance information about whether there is any object on which the input of a gesture operation can be accepted in the respective screen.

When there is no object in the displayed user interface, the main control unit 402 determines whether a predetermined end signal has been input (S711). The predetermined end signal is a signal generated by the user pressing an end button not illustrated, for example. When no termination process signal has been received, the main control unit 402 moves the process again to step S702 to confirm whether there is any object in the displayed user interface.

When any object is displayed in the user interface, the main control unit 402 confirms whether a hover event has been received (S703). The hover event is an event that is generated when the user's fingertip is separated from the operation plane 204 by the touch threshold Th or more. The hover event has information on the coordinates of the fingertip as three-dimensional (X, Y, Z) information. The coordinates (X, Y, Z) of the fingertip contained in the hover event are called as hover coordinates. The hover coordinates of the fingertip are coordinates in the orthogonal coordinate system. The Z information in the hover coordinates is the information on fingertip height in the hover event, and the X and Y information indicate over what coordinates on the operation plane 204 the fingertip is performing a hover operation.

The main control unit 402 acquires the fingertip height information in the received hover event (S704). The main control unit 402 extracts the Z information from the hover coordinates.

The main control unit 402 calculates the amount of an offset according to the height of the fingertip acquired at S704 (S705). The main control unit 402 calculates the offset amount δh using the fingertip height Z acquired at S704 and the following equation in which Th represents the touch threshold described above.

[Equation 1]

δh=0(0≦Z≦Th)

δh=aZ+b(Z>Th)

Th≡−b/a(Th>0) (4)

When the distance between the user's fingertip and the operation plane 204 is equal to or less than the touch threshold (0≦Z≦Th), the gesture reaction area size and the object reaction area size are equal. Therefore, when Z=Th, δh=aTh+b and δh=0.

When the distance between the user's fingertip and the operation plane 204 is larger than the touch threshold (Z>Th), the gesture reaction area and the offset amount δh become larger with increase in the distance Z between the fingertip and the operation plane. Therefore, a>0.

The touch threshold Th takes a predetermined positive value and b<0.

By deciding a and b, the offset amount can be calculated by the foregoing equation.

The main control unit 402 calculates the gesture reaction area using the offset amount δh determined at S705 and the “display coordinates” and “display size” in the object management table (S706). The main control unit 402 calls the object management table illustrated in FIG. 8B from the RAM 303 to acquire the display coordinates and the display size. The main control unit 402 decides the gesture reaction area coordinates and the gesture reaction area size such that the gesture reaction area is larger than the display size by the offset amount δh, and registers the same in the object management table. The main control unit 402 executes the process at S706 to generate the object management table as illustrated in FIG. 8E.

The main control unit 402 applies the gesture reaction area calculated at S706 on the objects (S707). At S707, the main control unit 402 applies the gesture reaction area on the user interface according to the object management table generated at S706. By executing the process at S707, the areas shown by dotted lines in FIG. 8D are set as gesture reaction areas.

The main control unit 402 refers to the gesture reaction area coordinates and the gesture reaction area sizes set in the object management table stored in the RAM 303 (S708). The main control unit 402 calculates the gesture reaction areas for the objects based on the referred gesture reaction area coordinates and gesture reaction area sizes. For example, referring to FIG. 8E, the gesture reaction area for the object with the ID “2” is a rectangular area surrounded by four points at (180, 330), (180, 390), (320, 330), and (320, 390).

The main control unit 402 determines whether, of the hover coordinates of the fingertip stored in the hover event received at S703, the value of (X, Y) falls within the gesture reaction area acquired at S708 (S709).

The value of (X, Y) in the hover coordinates is determined to fall within the gesture reaction area acquired by the main control unit 402 at S708, the main control unit 402 sends a message to the user interface unit 403 to change the display of the object (S710). The user interface unit 403 receives the message and performs a display switching process. Accordingly, when the fingertip is in the gesture reaction area, the color of the object can be changed. Changing the color of the object on which a hover operation is accepted as described above allows the user to recognize the object on the operation plane pointed by the user's fingertip. FIG. 8D illustrates the state in which the fingertip of the hand 806 is not on the object 802 but is in the gesture reaction area 812, and the color of the button is changed. In both the case in which the touch operation is accepted as illustrated in FIG. 8A and the case in which the hover operation is accepted as illustrated in FIG. 8D, the color of the object on which the input is accepted is changed. Alternatively, the user interface after acceptance of the input may be changed depending on the kind of the gesture operation. For example, when a touch operation is accepted, a screen transition may be made in accordance with the touched object, and when a hover operation is accepted, the color of the object on which the input is accepted may be changed. In the embodiment, the color of the object on which a hover operation is accepted is changed. However, the display on the acceptance of a hover operation is not limited to the foregoing one. For example, the brightness of the object on which a hover operation is accepted may be increased, or an annotation or the like in a balloon may be added to the object on which a hover operation is accepted.

The CPU 302 confirms whether the termination processing signal generated by a press of an end button not illustrated has been received. When the termination processing signal has been received, the CPU 302 terminates the process (S711). When no termination processing signal has been received, the CPU 302 returns to step S702 to confirm whether there is an object in the UI.

By repeating the foregoing process, it is possible to change the size of the gesture reaction area for the object according to the height of the fingertip. Even though the distance between the user's fingertip and the operation plane is long, the gesture reaction area becomes large. Accordingly, even when the position of the user's fingertip for a hover operation shifts from the display area of the object, the object is allowed to react.

As the fingertip becomes closer to the object, the gesture reaction area becomes smaller. Accordingly, when the user's fingertip is close to the operation plane, a gesture operation on the object in an area close to the display area of the object can be accepted. When the user brings the fingertip from a place distant from the operation plane to the object, the area where a hover operation is accepted on the object is gradually brought closer to the area where the object is displayed. When the user brings the fingertip closer to the operation plane while continuously selecting the object by a hover operation, the fingertip can be guided to the area where the object is displayed.

At S705 described in FIG. 7, as far as the user's fingertip is seen in the angle of view of the distance image sensor unit 208, the gesture reaction area is made larger with increase in the height Z of the finger with no limit on the degree of the increase.

The method for calculating the offset amount is not limited to the foregoing one. The size of the gesture reaction area may be no longer made larger at a predetermined height H or higher. The CPU 302 calculates the offset amount δh at S705 by the following equation:

[Equation 2]

δh=0(0≦Z≦Th)

δh=aZ+b(Th<Z≦H)

δh=aH+b(Z>H)

Th≡−b/a(Th>0) (5)

In the foregoing equation, H represents a constant of a predetermined height (H>Th).

In the foregoing equation, when the height Z of the fingertip is larger than the predetermined height H, the offset amount δh is constantly aH+b. When the fingertip and the operation plane are separated from each other in excess of the predetermined height or higher, the offset amount δh can be made constant.

In the case of using the method of the embodiment, when the space between the objects is small, the gesture reaction areas for the objects may overlap. Accordingly, with regard to a space D between the objects, the maximum value of the offset amount δh may be D/2.

FIGS. 8F and 8G schematically illustrate a user interface and gesture reaction areas where the offset amount δh becomes 40 mm depending on the distance between the user's fingertip and the operation plane 204, and an object management table.

Referring to FIGS. 8F and 8G, the distance D between an object 801 and an object 802 is 50 mm. When the offset amount δh is 40 mm, the gesture area for the object 1 and the gesture reaction area for the object 2 overlap. Accordingly, in the object management table illustrated in FIG. 8G, the offset amount δh between the object 801 and the object 802 is D/2, 25 mm. At that time, there is no overlap with the other gesture reaction areas for objects on the upper and lower sides of the button object 801 and the button object 802, that is, along the Y direction, even when the offset amount δh is 40 mm. Therefore, the offset amount δh=40 mm is set along the vertical direction of the button object 801 and the button object 802. FIGS. 8F and 8G illustrate the case where the maximum value of the offset amount δh is D/2 for the objects other than the object 801 and the object 802.

For objects of different display shapes such as an object 804 with ID of 4 and an object 805 with ID of 5, the offset calculated for either one of the objects is applied on a priority basis as illustrated in FIG. 8F. Then, for the other object, an offset area is set so as not to overlap the gesture reaction area for the one object. Referring to FIG. 8F, the gesture area in which the offset amount calculated for the object 804 with ID of 4 is applied on a priority basis is set, and the gesture reaction area for the object 805 is set so as not to overlap the gesture reaction area for the object 804. The objects for which the gesture reaction areas are to be applied on a priority basis are decided in advance by the shapes and types of the objects. For example, the button-type objects 801 to 803 are given a priority level of 1, the rectangular object 804 is given a priority level of 2, and the circular object 805 is given a priority level of 3. The gesture reaction areas are decided according to the decided priority ranks. The types and priority ranks of the objects are read from the HDD 305 and stored in a field not illustrated in the object management table by the CPU 302 at the time of generation of the object management table. The method for determining the gesture reaction area in the case where there is an overlap between the gesture reaction areas for the objects of different shapes is not limited to the foregoing method.

In the embodiment, the offset amount δh is determined by the linear equation at S705. The function for determining the offset amount δh may be any one of monotonically increasing functions where the value of δh becomes larger with increase in the height Z of the fingertip.

In addition, the function for determining the offset amount δh may be the same for all the objects displayed on the operation plane 204 or may be different among the objects. With different functions for the objects, it is possible to customize the reaction sensitivity to hovering for the respective objects.

In the embodiment, the operations of the camera scanner 101 when one user operates the operation plane 204 and one fingertip is detected have been described. Alternatively, a plurality of users may operate the operation plane 204 at the same time or one user may operate the operation plane 204 by both hands. In this case, of a plurality of fingertips detected in the captured image of the operation plane 204, the offset amount δh is decided with a high priority given to the fingertip smaller in the value of the height Z of the fingertip from the operation plane.

In the first embodiment, a hover operation is accepted as far as the distance between the user's fingertip and the operation plane is larger than the touch threshold and the user's fingertip is within the imaging area. Alternatively, no hover operation may be detected when the distance between the operation plane and the fingertip is larger than a predetermined threshold different from the touch threshold.

By using the method of the first embodiment, the gesture reaction area can be made larger with increase in the distance between the fingertip and the operation plane. Accordingly, it is possible to allow the object to be operated by the user to react even with changes in the distance between the user's operating fingertip and the operation plane.

### Second Embodiment

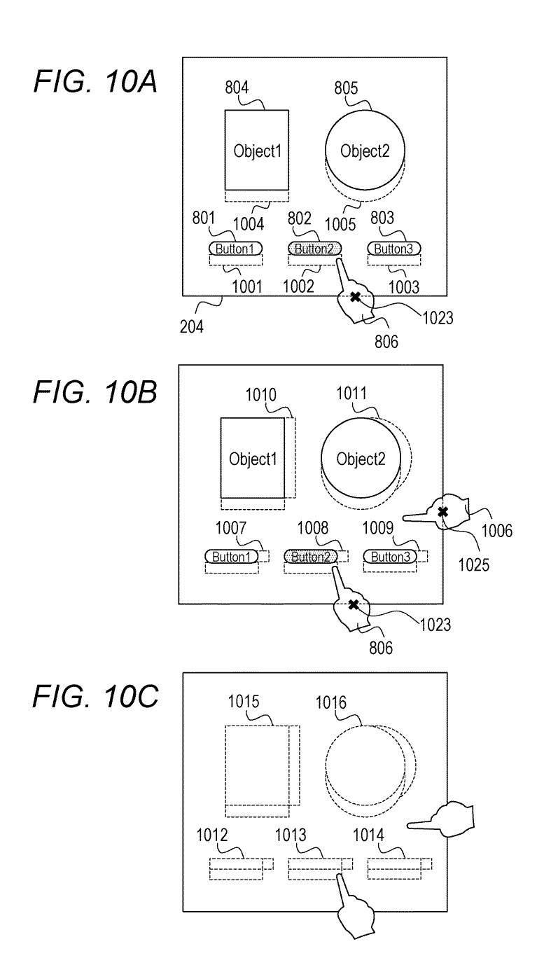

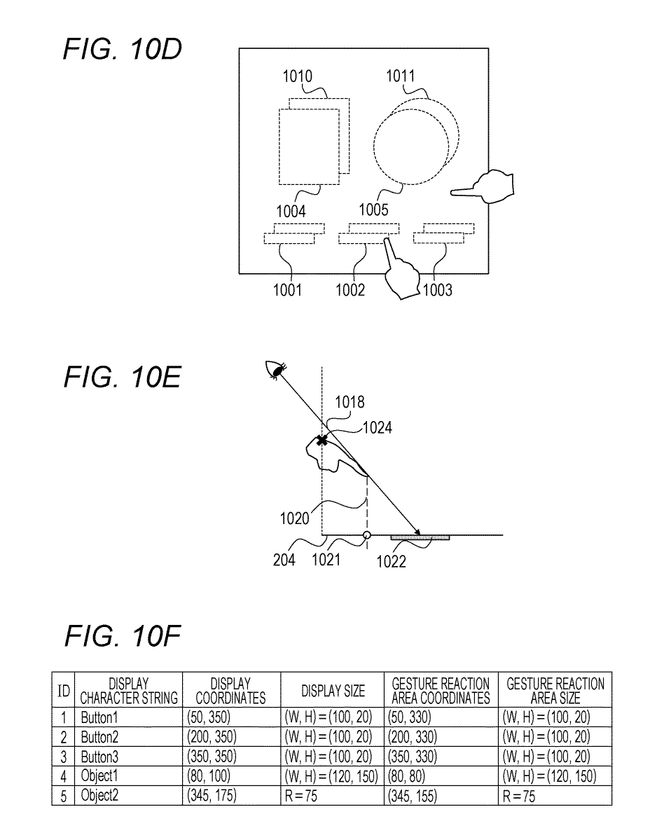

In the first embodiment, the size of the gesture reaction area is changed depending on the distance between the user's fingertip executing a gesture operation and the operation plane. However, when the user tries to perform a gesture operation obliquely from above the operation plane, the position of the gesture operation by the user tends to be closer to the user's body than the display position of the object to be operated as illustrated in FIG. 10E.

According to a second embodiment, descriptions will be given as to a method for changing the position of the gesture reaction area by which to detect the distance between the user's fingertip performing a gesture operation and the operation plane and the user's position.

The second embodiment will be described with reference to the schematic views of a user interface on the operation plane 204 and a schematic view of an object management table in FIGS. 10A to 10F. Referring to FIGS. 10A to 10F, the camera scanner 101 detects the entry positions of user's hands and decides the directions in which the gesture detection areas are to be moved on the basis of the detected entry positions of the hands.

FIGS. 10A and 10F are a schematic view of the operation plane 204 on which the user is performing a hover operation while holding a fingertip over the object 802 displayed on the operation plane 204 and a schematic view of an object management table. FIGS. 10A and 10F indicate the case where a movement amount S of the gesture reaction areas is 20 mm. Therefore, gesture reaction areas 1001 to 1005 corresponding to the objects 801 to 805 are all moved 20 mm toward the lower side of the diagram, that is, toward the entry side of the user's hand.

Referring to FIG. 10A, 1023 represents the entry position of the hand. The method for determining the entry position of the hand will be described later.

In accordance with the entry of the hand 806 into the operation plane 204, the camera scanner 101 detects the distance between the fingertip and the operation plane 204 and moves the gesture reaction areas based on the detected distance.

In the object management table illustrated in FIG. 10F, the gesture reaction areas are moved toward the side on which the entry position of the user's hand is detected by 20 mm from the object display areas. The degree of movement of the gesture reaction areas from the object display areas is decided by the distance between the user's fingertip and the operation plane 204.

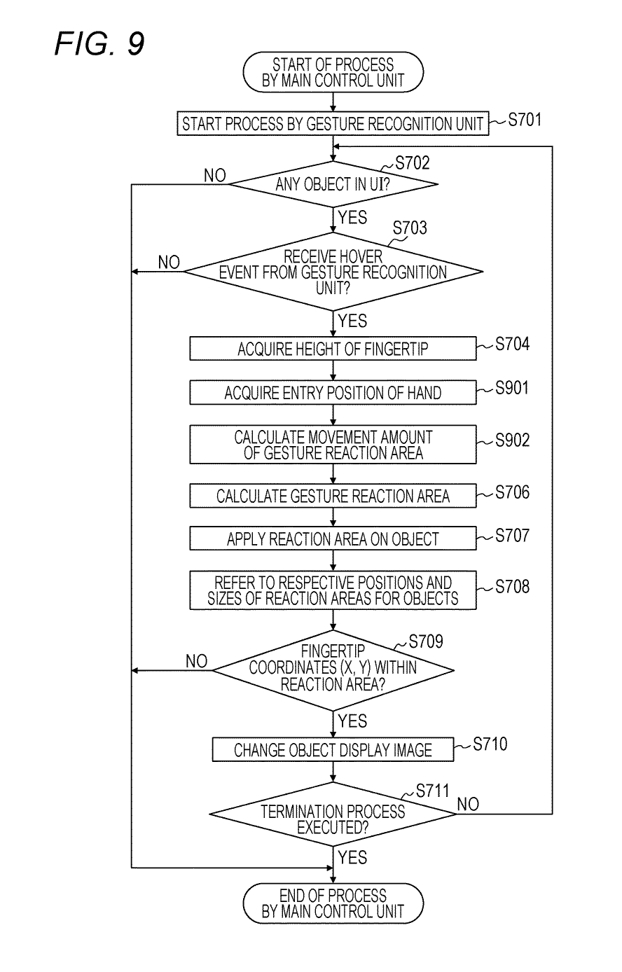

FIG. 9 is a flowchart of a process performed in the second embodiment. The HDD 305 stores a program for executing the process described in the flowchart of FIG. 9. The CPU 302 executes the program to implement the process.

S701 to S704 and S706 to S711 described in FIG. 9 are the same as those in the first embodiment and descriptions thereof will be omitted.

In the second embodiment, after the acquisition of the height of the fingertip at S704, the main control unit 402 acquires the entry position 1023 of the hand (S901). The entry position of the hand is at the point 1023 in FIG. 10A and at the point 1024 in FIG. 10E, which can be expressed in the orthogonal coordinate system. In the embodiment, the camera scanner 101 uses the outer shape of the operation plane 204 and the XY coordinates of the entry position of the hand to determine from which direction the hand has entered in the operation plane 204.

At S901, the gesture recognition unit 409 executes processes in S601 to S632 described in FIG. 6A to generate three-dimensional point groups of the hand and project orthographically the same onto the operation plane 204, thereby detecting the outer shape of the hand. The gesture recognition unit 409 sets the entry position of the hand at the midpoint of a line segment formed by two intersecting points of the detected outer shape of the hand and the outer shape of the operation plane 204.

The main control unit 402 calculates the movement amount of the gesture reaction areas based on the height of the fingertip acquired at S704 (S902). In this case, the movement amount of the gesture reaction areas from the object display areas is larger with increase in the height of the fingertip detected at S704.

The movement amount may be expressed by a linear function as in the first embodiment or any other function as far as the function increases monotonically with respect to the height of the fingertip.

The main control unit 402 calculates the gesture reaction areas based on the movement amount of the gesture reaction areas determined at S902, and registers the same in the object management table stored in the RAM 303 (S706). For example, in the object management table illustrated in FIG. 10E, the movement amount S is 20 mm, and the display sizes and the gesture reaction area sizes of the objects are the same, and the gesture reaction area coordinates are moved 20 mm from the display coordinates. The following process is the same as that described in FIG. 7 and descriptions thereof will be omitted.

FIGS. 9 and 10 illustrate the case where the gesture reaction areas are moved toward the entry side of the user's hand by the movement amount decided depending on the distance between the user's fingertip and the operation plane 204. The direction in which the gesture reaction areas are moved is not limited to the direction along the entry side of the user's hand. For example, the camera scanner 101 detects the positions of the user's eye and body from the captured image by the distance image sensor or the camera with sufficiently wide angles of view or any other camera not illustrated. Then, the camera scanner 101 may decide the direction in which the gesture reaction areas are moved based on the detected positions of the user's eye and body.

In the second embodiment, the movement amount of the gesture reaction areas are made larger with increase in the distance between the fingertip and the operation plane. Alternatively, the movement amount of the gesture detection areas may be no longer made larger when the distance between the fingertip and the operation plane becomes longer than a predetermined distance.

The movement of the gesture detection areas may be controlled such that there is no overlap between the display area and the gesture area of different objects. For example, in FIG. 10A, the movement amount may be controlled such that the gesture reaction area 1004 for the object 804 is moved so as not to overlap the display area for the object 801.

In the second embodiment, the position of the gesture reaction areas is moved depending on the distance between the user's fingertip and the operation plane. Alternatively, the first and second embodiments may be combined together to change the positions and sizes of the gesture reaction areas depending on the distance between the fingertip and the operation plane.

In the second embodiment, one fingertip is detected in the captured image of the operation plane. Descriptions will be given as to the case where a hand 1006 different from the hand 806 enters from another side of the operation plane 204 (the right side in the drawing) as illustrated in FIG. 10B.

In the state illustrated in FIG. 10B, the camera scanner 101 determines that the entry positions of the hands are at two points, that is, the point 1023 and a point 1025. Therefore, the camera scanner 101 determines that there are users on both the lower side and right side of the operation plane illustrated in FIG. 10B, and moves the gesture areas to the lower side and the right side of FIG. 10B.

The camera scanner 101 sets the gesture reaction areas 1001 to 1005 moved to the lower side of the operation plane and gesture reaction areas 1007 to 1011 moved to the right side of the operation plane as gesture reaction areas.

The object management table includes the gesture reaction coordinates and the gesture reaction area sizes with movement of the gesture reaction areas to the lower side of the operation plane and the gesture reaction area coordinates and the gesture reaction area sizes with movement of the gesture reaction areas to the right side of the operation plane. For example, in the object management table illustrated in FIG. 10F, the gesture reaction area coordinates with ID of “1” are set to (50, 330) and (80, 350), and the gesture reaction area sizes are set to (W, H)=(100, 20) and (100, 20). FIG. 10D corresponds to FIG. 10B, in which the gesture reaction areas with entries of the hands from the point 1023 and the point 1025 are indicated by dotted lines.

The main control unit 402 determines whether the X- and Y-components of the hover coordinates are included in either one of the two gesture reaction areas, and then determines whether a gesture reaction area is to be accepted.

In the second embodiment, the object display areas are moved according to the movement amount decided depending on the distance between the fingertip and the operation plane and sets the moved areas as gesture reaction areas. As illustrated in FIG. 10C, the gesture reaction areas and the display areas of the objects decided by the foregoing method after the movement may be put together and set as gesture reaction areas for hover operation. Referring to FIG. 10C, the areas 1012 to 1016 indicated by dotted lines are stored as gesture reaction areas in the object management table.

By executing the process in the second embodiment, even though the user's fingertip comes closer to the user side than the object to be selected at the time of a hover operation, the desired object is allowed to react.

### Third Embodiment

In the first embodiment, when the user's fingertip is at a position higher than the touch threshold Th, that is, when a hover operation is being operated, the gesture reaction areas are changed depending on the distance between the fingertip and the operation plane. In addition, in the first embodiment, the offset amount δh is 0 mm with the user's fingertip at a position lower than the touch threshold, that is, the object display areas and the gesture reaction areas are identical. In a third embodiment, the gesture reaction areas are set to be wider than the object display areas even when the distance between the user's fingertip and the operation plane is equal to or less than the touch threshold.

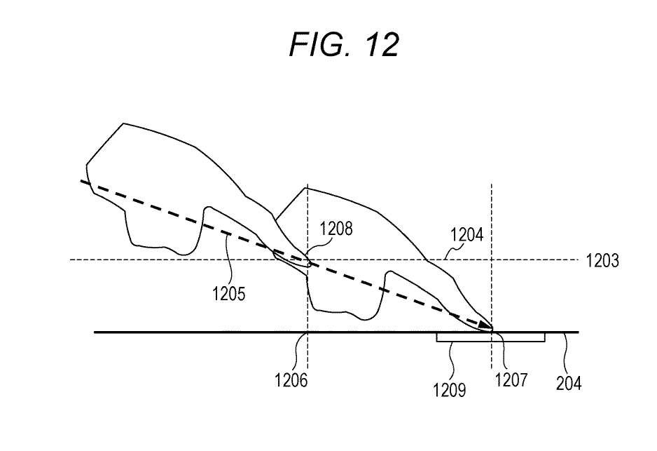

FIG. 12 is a side view of the state in which the user is performing a touch operation on an object 1209.

When detecting that the fingertip is at a position lower than a touch threshold 1203, the camera scanner 101 accepts a touch operation.

Referring to FIG. 12, the user's fingertip comes closer to the object 1209 on a track with reference number 1205. In the (X, Y) coordinates where a touch operation is detected, a point 1208 is orthographically projected as a point 1206 onto the operation plane. Accordingly, even though the user moves the finger to touch the object 1209 and the fingertip comes to a position lower than the touch threshold, the user cannot perform a touch operation on the desired object 1209.

Accordingly, in the third embodiment, the offset amount is set for a touch operation as well, and the gesture reaction areas reactive to a touch operation are made larger than the object reaction areas.

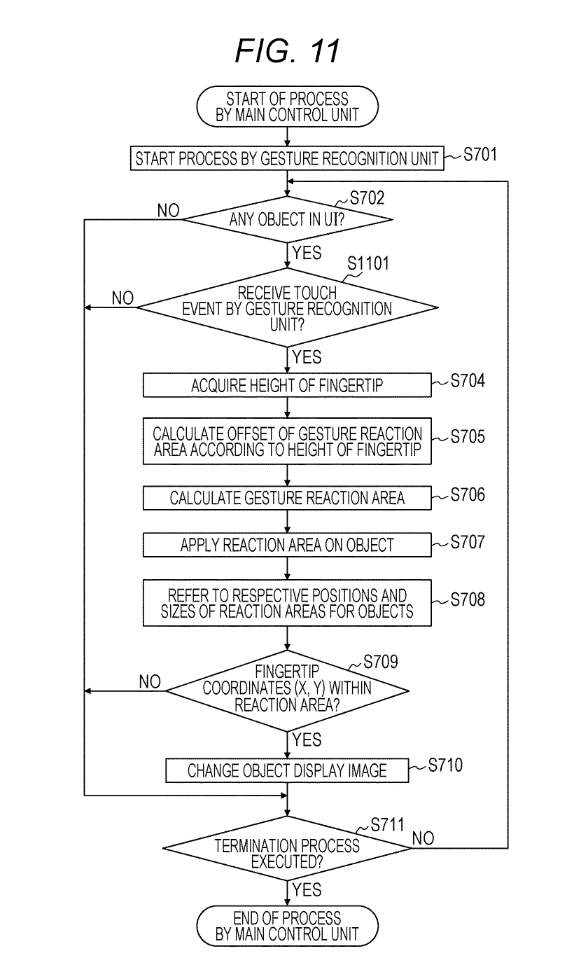

The process in the third embodiment will be described with reference to the flowchart of FIG. 11.

The HDD 305 stores a program for executing the process described in the flowchart of FIG. 11. The CPU 302 executes the program to perform the process.

S701, S702, and S704 to S711 in the process of FIG. 11 are the same as those in the process of FIG. 7 and descriptions thereof will be omitted.

When determining at S702 that an object is displayed in the user interface on the operation plane 204, the main control unit 402 determines whether the gesture recognition unit 409 has received a touch event (S1101).

The touch event is an event that occurs when the distance between the user's fingertip and the operation plane 204 is equal to or less than a predetermined touch threshold in the process described in FIG. 6. For a touch event, the coordinates where the touch operation has been detected are stored in the orthogonal coordinate system.

When detecting no touch event at S1101, the main control unit 402 moves the process to S711 to determine whether a termination process has been executed.

When detecting a touch event at S1101, the main control unit 402 acquires the height of the fingertip, that is, Z-direction information from the touch event (S704).

The main control unit 402 calculates the offset amount δt for the gesture reaction areas depending on the height acquired at S704 (S705). In the third embodiment, the following equation is used to calculate the offset amount δt:

[Equation 3]

δt=cZ+δt₁(0≦Z≦Th)

δt₁>0

c>0 (6)

In the foregoing equation, δt1 is the intercept of the equation, which represents the offset amount with the touch of the user's fingertip on the operation plane 204. When the offset amount δt1 takes a positive value, the touch reaction areas are set at any time to be larger than the object display areas.

The offset amount δt becomes larger with increase in the distance between the fingertip and the operation plane 204, and therefore c is a positive constant.

The process after the calculation of the gesture reaction areas by the main control unit 402 is the same as that in the first embodiment described in FIG. 7 and descriptions thereof will be omitted.

FIG. 11 describes the process in the case where, when the fingertip becomes at a position lower than the touch threshold, the gesture reaction areas are changed depending on the distance between the fingertip performing a touch operation and the operation plane.

The method for deciding the gesture reaction areas for touch operation is not limited to the foregoing one. For example, the offset amount may be decided in advance according to the touch threshold so that the pre-decided gesture reaction areas may be applied according to the detection of a touch event.

In addition, at S705 in the process described in FIG. 11, the offset amount δt may be calculated using the value of the touch threshold, not the height of the finger detected from a touch event, and the calculated offset amount may be applied in the object management table. In this case, the offset amount δt takes a predetermined value at every time. To set the offset amount by using the value of the touch threshold, the offset amount δt calculated in advance using the touch threshold may be stored in the information processing apparatus or the offset amount δt may be calculated at the time of receipt of a touch event.

In the embodiment, the height of the user's fingertip is equal to or less than the touch threshold. Alternatively, the process in the first embodiment may be performed when the height of the user's fingertip is more than the touch threshold. This allows the gesture reaction areas to be changed for both a touch operation and a hover operation.

In the embodiment, the gesture reaction areas reactive to a touch operation are made larger in size. Alternatively, the touch reaction areas may be shifted as in the second embodiment.

By carrying out the third embodiment, the user can cause the desired object to react when trying to perform a touch operation on that object by moving the fingertip on the track as illustrated with 1205 in FIG. 12.

### Fourth Embodiment

In the third embodiment, a touch operation is detected when the height of the user's fingertip becomes equal to or less than the touch threshold, and the sizes of the gesture reaction areas reactive to a touch operation are decided from the height of the fingertip at the time of the touch operation.

In contrast to a touch operation of moving a fingertip toward an object and touching the object, there is a release operation of separating the fingertip from the touched object. Setting the touch threshold for a touch operation and the release threshold for a release operation to the same value may lead to continuous alternate detection of a touch operation and a release operation when the height of the user's fingertip is at a height close to the touch threshold. Even though the user moves a fingertip at a height near the touch threshold, when repeated touch and release operations are performed alternately, the display given by the projector 207 becomes continuously changed and hard to view. The foregoing phenomenon is called chattering. To eliminate the chattering, it has been proposed to set the touch threshold and the release threshold at different heights.

In the third embodiment, the process performed by the camera scanner 101 with the touch threshold and the release threshold will be described.

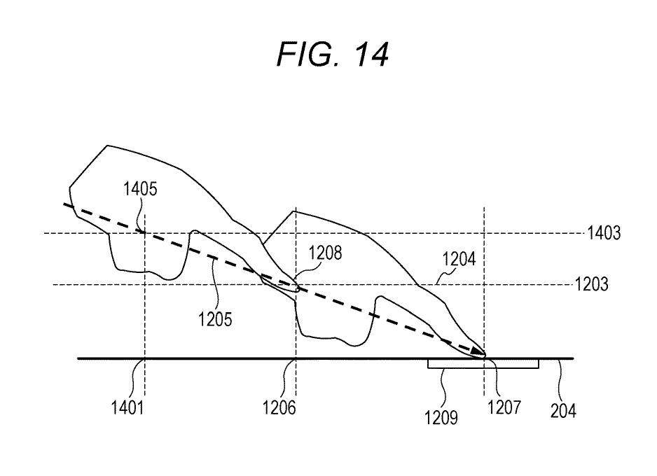

FIG. 14 is a diagram schematically illustrating the relationship among the movement of a fingertip on the operation plane, the touch threshold, and the release threshold.

In FIG. 14, 1203 is the touch threshold and 1403 is the release threshold. The action of the user's finger moving closer to the operation plane 204 along a track 1205 and separating from the operation plane 204 along the track 1205 will be described as an example.

When the user moves the fingertip toward the operation plane 204 and the fingertip reaches a position 1208, a touch operation is detected. Meanwhile, when the user moves the fingertip from the operation plane 204 along the track 1205 and the fingertip reaches a position 1405, a release operation is detected. In the case of FIG. 14, the release threshold is more distant from the operation plane than the touch threshold, and therefore the gesture reaction area for detection of a release operation is set to be larger than the gesture reaction area for detection of a touch operation. Accordingly, even when, after the touch of the operation plane, the fingertip is slightly moved on the operation plane, the information processing apparatus can determine that there is a release operation on the touched object.

In a fourth embodiment, the gesture recognition unit 409 recognizes three kinds of gesture operations, a touch operation, a hover operation, and a release operation. The gesture recognition unit 409 executes the process in the flowchart described in FIG. 6. Hereinafter, only the differences from the first embodiment will be described.

S601 to S603 and S605 are the same as those in the first embodiment and descriptions thereof will be omitted.

The gesture recognition unit 409 determines at S604 whether a touch operation, a hover operation, or a release operation is being performed or no gesture is being performed.

The gesture recognition unit 409 performs processes in S641, S642, and S646 in the same manner as in the first embodiment.

The gesture recognition unit 409 determines at S643 to which of the cases described below the calculated distance applies. When the detected distance is equal to or less than the touch threshold, the gesture recognition unit 409 moves the process to S644 to detect a touch operation. When the detected distance is more than the release threshold, the gesture recognition unit 409 moves the process to S645 to detect a hover operation. When the detected distance is more than the touch threshold and is equal to or less than the release threshold, the gesture recognition unit 409 detects a release operation (not illustrated). The process after the detection of the gesture operation is the same as that in the first embodiment and descriptions thereof will be omitted.

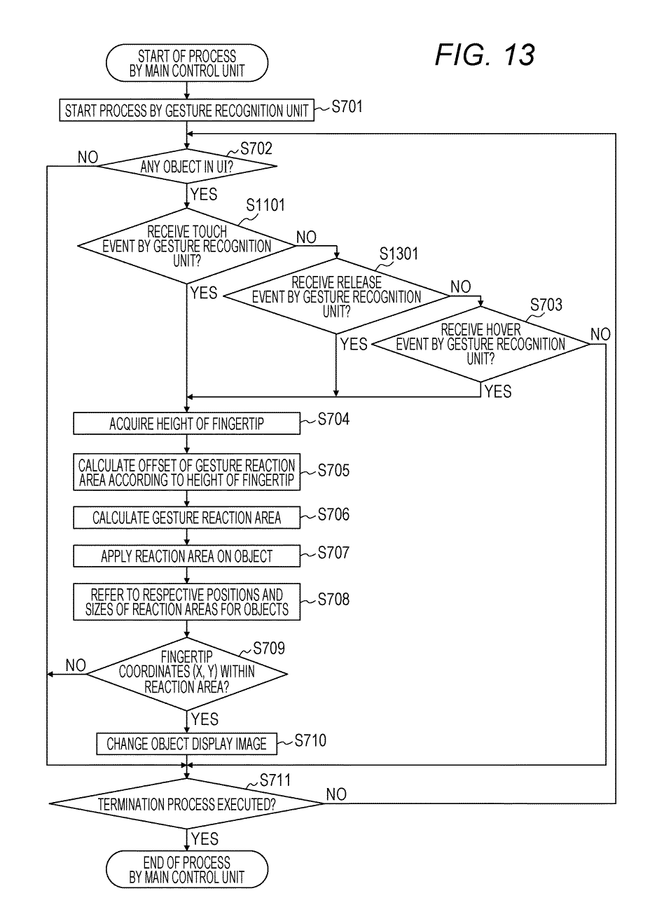

FIG. 13 is a flowchart of the process executed by the camera scanner 101 with the touch threshold and the release threshold. The HDD 305 stores a program for executing the process described in FIG. 13. The CPU 302 executes the program to perform the process.

S701, S702, and S704 to S711 are the same as those in the process described in FIG. 7 and process in S1101 is the same as that in the process described in FIG. 11, and descriptions thereof will be omitted.

When not determining at S1101 that any touch event has been received, the main control unit 402 determines whether a release event has been received (S1301). The release event is an event that occurs when the height of the user's fingertip changes from a position lower than the release threshold 1403 to a position higher than the release threshold 1403. For a release event, the coordinates of the position where a release operation is detected are represented in the orthogonal coordinate system.

When receiving a release event, the main control unit 402 moves to S704 to acquire the height of the fingertip from the release event. When a release operation is performed, the position of the release operation takes the value of the Z coordinate in the orthogonal coordinate system representing the release event.

The main control unit 402 calculates the offset amount according to the height of the fingertip (S705). The equation for use in the calculation of the gesture reaction areas is a monotonically increasing linear function as in the first embodiment and the third embodiment. The proportional constant may be different from a in Equation (4) in the first embodiment or c in Equation (6) in the third embodiment.

The main control unit 402 sets the gesture reaction areas based on the offset amount determined at S705 (S706). The subsequent process is the same as that described in FIG. 7 and descriptions thereof will be omitted.

When not receiving any release event at S1301, the main control unit 402 determines whether a hover event has been received (S703). When a hover event has been received, the main control unit 402 executes process in S704 and subsequent steps according to the received hover event.

By using separately the touch threshold and the release threshold and setting the respective gesture reaction areas for a touch operation and a release operation, it is possible to determine on which of the objects the touch operation and the release operation is performed.

In the example of FIG. 13, the gesture reaction areas are changed according to the height of the fingertip at the time of a release operation. Alternatively, when a release operation is performed, the gesture reaction areas determined according to the value of the release threshold may be applied to determine on which of the objects the release operation is performed.

In the example of FIG. 13, the gesture recognized by the gesture recognition unit 409 is a touch operation or a release operation. Alternatively, when the height of the user's fingertip is more than the release threshold, the gesture recognition unit may receive a hover event and change the gesture reaction areas according to the height of the fingertip as in the first embodiment.

In the case of FIG. 13, the sizes of the gesture reaction areas are changed according to the height of the fingertip. Alternatively, the gesture reaction areas may be moved according to the height of the fingertip as in the second embodiment.

In the embodiment, when the fingertip is at a height more than the touch threshold and equal to or less than the release threshold, the gesture recognition unit detects that a release operation is performed. Alternatively, when detecting that the fingertip at a height equal to or less than the release threshold is moved to a height equal to or more than the release threshold, the gesture recognition unit may determine that a release operation is performed.

By the foregoing process, it is possible to notify both a touch event and a release event to the object as desired by the user even when the release threshold is higher than the touch threshold and the release position is largely shifted from the position desired by the user than the touch position.

### Other Embodiments

In the first to fourth embodiments, the user performs an operation by a finger. Instead of a finger, the user may use a touch pen or the like to perform an operation.

In the first to fourth embodiments, when a fingertip is within the area at a height equal to or less than the touch threshold, the gesture recognition unit 409 determines that a touch operation is performed. Alternatively, when a transition occurs from the state in which the fingertip at a height equal to or more than the touch threshold to the state in which the fingertip is at a height equal to or less than the touch threshold, the gesture recognition unit 409 may determine that a touch operation is performed and notify the touch event.

According to the information processing apparatus described herein that detects an operation over the operation plane, it is possible to guide the user's fingertip to the display area of the object by changing the area reactive to a hover operation depending on the distance between the fingertip and the operation plane.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-148209, filed Jul. 28, 2016, which is hereby incorporated by reference herein in its entirety.

What is claimed is:

1. An information processing apparatus comprising:
a processor; and
a memory storing instructions, when executed by the processor, causing the information processing apparatus to function as:
a display unit configured to display an image including an item on a plane;
an imaging unit configured to capture the image including the item on the plane from above the plane;
an identification unit configured to identify a position of a pointer from the image captured by the imaging unit;
an acquisition unit configured to acquire a distance between the plane and the pointer;
a selection unit configured to, when the position of the pointer identified by the identification unit in the image captured by the imaging unit falls within a predetermined area including at least part of the item, select the item; and
a control unit configured to change a size of the predetermined area based on the distance acquired by the acquisition unit.

2. The information processing apparatus according to claim 1, wherein the control unit makes the size of the predetermined area larger with an increase in the distance acquired by the acquisition unit.

3. The information processing apparatus according to claim 2, wherein, when the distance acquired by the acquisition unit is shorter than a predetermined distance, the control unit sets the size of the predetermined area to a constant size.

4. The information processing apparatus according to claim 1, further comprising a storage unit configured to store a table for managing the display position and size of the item displayed by the display unit and the position and size of the predetermined area in association with each other, wherein
the selection unit determines whether the position of the pointer identified by the identification unit falls within the predetermined area based on information in the table stored in the storage unit.

5. The information processing apparatus according to claim 1, wherein the control unit moves the position of the predetermined area based on the distance acquired by the acquisition unit.

6. The information processing apparatus according to claim 5, wherein the control unit increases the movement amount of the position of the predetermined area with an increase in the distance acquired by the acquisition unit.

7. The information processing apparatus according to claim 1, wherein the control unit performs a control such that there is no overlap between the predetermined area corresponding to a first item displayed by the display unit and the predetermined area corresponding to a second item displayed by the display unit.

8. The information processing apparatus according to claim 1, wherein the pointer is a fingertip of a user or a tip of a stylus pen.

9. The information processing apparatus according to claim 1, wherein switching takes place between items displayed by the display unit in accordance with the selection of the item by the selection unit.

10. The information processing apparatus according to claim 1, wherein the display unit is a projector.

11. An information processing apparatus comprising:
a processor; and
a memory storing instructions, when executed by the processor, causing the information processing apparatus to function as:
a display unit configured to display an image including an item on a plane;
an imaging unit configured to capture the image including the item on the plane from above the plane;
an identification unit configured to identify a position of a pointer from the image captured by the imaging unit;
an acquisition unit configured to acquire a distance between the plane and the pointer;
a selection unit configured to, when the position of the pointer identified by the identification unit in the image captured by the imaging unit falls within a predetermined area including at least part of the item, select the item; and
a control unit configured to change a position of the predetermined area based on the distance acquired by the acquisition unit.

12. A control method of an information processing apparatus, comprising:
displaying an image including an item on a plane;
capturing the image from above the plane;
identifying a position of a pointer from the captured image by the capturing;
acquiring a distance between the plane and the pointer;
when the position of the pointer identified by the identifying in the image captured by the capturing falls within a predetermined area including at least part of the item, selecting the item; and
controlling and changing a size of the predetermined area based on the distance acquired by the acquiring.

13. A storage medium storing a computer program for executing a control method of an information processing apparatus, the control method comprising:
displaying an image including an item on a plane;
capturing the image from above the plane;
identifying a position of a pointer from the captured image by the capturing;
acquiring a distance between the plane and the pointer;
when the position of the pointer identified by the identifying in the image captured by the capturing falls within a predetermined area including at least part of the item, selecting the item; and
controlling and changing a size of the predetermined area based on the distance acquired by the acquiring.
